(19) United States
(12) Patent Application Publication
(10) Pub. No.: US 2004/0258162 A1
(43) Pub. Date: Dec. 23, 2004

(54) Systems and methods for encoding and decoding video data in parallel

(76) Inventors: Stephen Gordon, North Andover, MA (US); Reinhard Schumann, Exeter, NH (US)

Correspondence Address: MCANDREWS HELD & MALLOY, LTD, 500 WEST MADISON STREET, SUITE 3400, CHICAGO, IL, 60661

(21) Appl. No.: 10/871,640

(22) Filed: Jun. 17, 2004

Related U.S. Application Data
(60) Provisional application No. 60/480,415, filed on Jun. 20, 2003.

(51) Int. Cl. H04N 7/12

(52) U.S. Cl. 375/240.25; 375/240.24; 375/240.12

(57) ABSTRACT

Presented herein is a system and apparatus for accelerating arithmetic decoding of encoded data. In one embodiment, there is presented a decoder system for decoding compressed video data. The decoder comprises a host processor, a first decoder engine, and a second decoder engine. The host processor finds a first portion of the compressed video data and a second portion of the compressed video data. The first portion of the compressed video data and the second portion of the compressed video data are data independent from each other. The first decoder engine decodes the first portion of the video data. The second decoder engine decodes the second portion of the video data, while the first decoder engine decodes the first portion of the video data.

### RELATED APPLICATIONS

This application claims the benefit of “Video Data Processing”, Provisional Application for U.S. Patent, Ser. No. 60/480,415, filed Jun. 20, 2003, by Schumann, et. al.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Data compression allows transferring and storage of large amounts of media, such as audio and video, with less bandwidth and memory. However, decompressing compressed data utilizes a large amount of computation and processing. This can dramatically increase the load on the processing elements of a decoder, especially for presenting the media in real time.

Parallel processing is a popular approach for processing and computationally intense operations. Parallel processing uses multiple processing elements to perform different portions of the operation simultaneously.

However, many compression algorithms and standards use recursion for compressing data. Recursion introduces data dependencies between different portions of the compressed media. The data dependencies make parallel processing complex, because information contained in a previously decoded portion of the media is to be used for decoding subsequent portions of the media.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein are systems and methods for encoding and decoding video data in parallel.

In one embodiment, there is presented a decoder system for decoding encoded video data. The decoder comprises a host processor, a first decoder engine, and a second decoder engine. The host processor finds a first portion of the encoded video data and a second portion of the encoded video data. The first portion of the encoded video data and the second portion of the encoded video data are data independent from each other. The first decoder engine decodes the first portion of the video data. The second decoder engine decodes the second portion of the video data, while the first decoder engine decodes the first portion of the video data.

In another embodiment, there is presented a method for decoding encoded video data. The method comprises finding a first portion of the encoded video data and a second portion of the encoded video data, wherein the first portion of the encoded video data and the second portion of the encoded video data are data independent from each other; decoding the first portion of the video data; and decoding the second portion of the video data, while decoding the first portion of the video data.

In another embodiment, there is presented an encoder system for encoding video data. The encoder system comprises a host processor, a first encoding engine, and a second encoding engine. The host processor selects a first portion of the video data and a second portion of the video data. The first encoder engine encodes the first portion of the video data independently from the second portion of the video data, thereby resulting in a first encoded portion of the video data. The second encoder engine encodes the second portion of the video data independently from the first portion of the video data, thereby resulting in a second encoded portion of the video data, while the first encoder engine encodes the first portion of the video data.

In another embodiment, there is presented a method for encoding video data. The method comprises selecting a first portion of the video data and a second portion of the video data; encoding the first portion of the video data independently from the second portion of the video data, thereby resulting in a first encoded portion of the video data; and encoding the second portion of the video data independently from the first portion of the video data, thereby resulting in a second encoded portion of the video data, while encoding the first portion of the video data.

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1A is a block diagram of an exemplary video decoder in accordance with an embodiment of the present invention;

FIG. 1B is a block diagram of an exemplary video encoder in accordance with an embodiment of the present invention;

FIG. 2 is a block diagram of a frame;

FIG. 3A is a block diagram describing spatially encoded macroblocks;

FIG. 3B is a block diagram describing temporally encoded macroblocks;

FIG. 3C is a block diagram describing the encoding of a prediction error;

FIG. 4 is a block diagram describing macroblock interdependencies;

FIG. 5 is a block diagram describing interdependent macroblocks;

FIG. 6 is a video decoder in accordance with another embodiment of the present invention; and

FIG. 7 is a video encoder in accordance with another embodiment of the present invention.

### DETAILED DESCRIPTION OF THE INVENTION

Certain aspects of the present invention improve parallel processing of video data by identifying one or more portions within the video data that are independent from other portions, and which thus can be processed in parallel with each other.

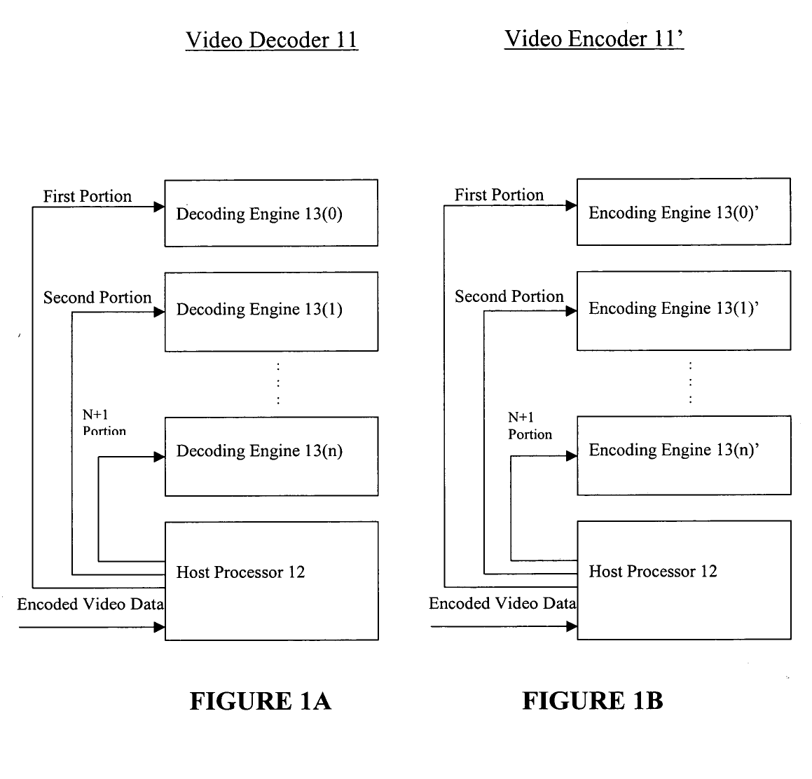

Referring now to FIG. 1A, there is illustrated a block diagram describing an exemplary video decoder 11 in accordance with an embodiment of the present invention. The video decoder 11 comprises a host processor 12, and a plurality of decoding engines 13(0) . . . 13(n), e.g., a first decoding engine 13(0), and a second decoding engine 13(1). The host processor 12 can comprise, for example, a central processing unit or a microcontroller. The decoding engines can comprise hardware accelerator units under the control of the host processor 12.

The video decoder 11 receives encoded video data. The host processor 12 finds different portions of the encoded video data that are data independent with respect to each other. The plurality of decoding engines 13 each decode a particular one of the different portions in parallel.

For example, the host processor 12 finds a first portion and second portion of the encoded video data, wherein the first portion of the encoded video data and the second portion of the encoded video data are data independent from each other. The first decoding engine 13(0) decodes the first portion of the encoded video data. The second decoding engine 13(1) decodes the second portion of the encoded video data, while the first decoding engine 13(0) decodes the first portion of the encoded video data.

Referring now to FIG. 1B, there is illustrated a block diagram describing an exemplary video encoder 11′ in accordance with an embodiment of the present invention. The video encoder 11′ comprises a host processor 12, and a plurality of encoding engines 13′(0) . . . 13′(n), e.g., a first encoding engine 13(0)′, and a second encoding engine 13(1)′. The host processor 12 can comprise, for example, a central processing unit or a microcontroller. The encoding engines 13′ can comprise hardware accelerator units under the control of the host processor 12.

The video encoder 11′ receives video data. The host processor 12 finds different portions of the video data to encode data independent with respect to each other. The plurality of encoding engines 13(0)′ . . . 13(n)′ each encode a particular one of the different portions in parallel.

For example, the host processor 12 finds a first portion and second portion of the video data to encode data independently with respect to each other. The first encoding engine 13(0)′ encodes the first portion of the video data independently from the second portion. The second encoding engine 13(1)′ encodes the second portion of the encoded video data, independently from the first portion of the video data, while the first encoding engine 13(0)′ encodes the first portion of the video data.

The video data can be encoded in accordance with any of a variety of standards. For example, the video data can be encoded in accordance with the H.264 standard. Where the encoded video data is encoded in accordance with the H.264 standard, the portions of the video data can comprise a structure known as a macroblock.

An exemplary compression standard, H.264, will now be described by way of example to illustrate both data interdependent portions of the video data, and independent portions of the video data. Although the H.264 standard is described, the present invention is not limited to the H.264 standard and can be used with other standards as well.

H.264 Standard

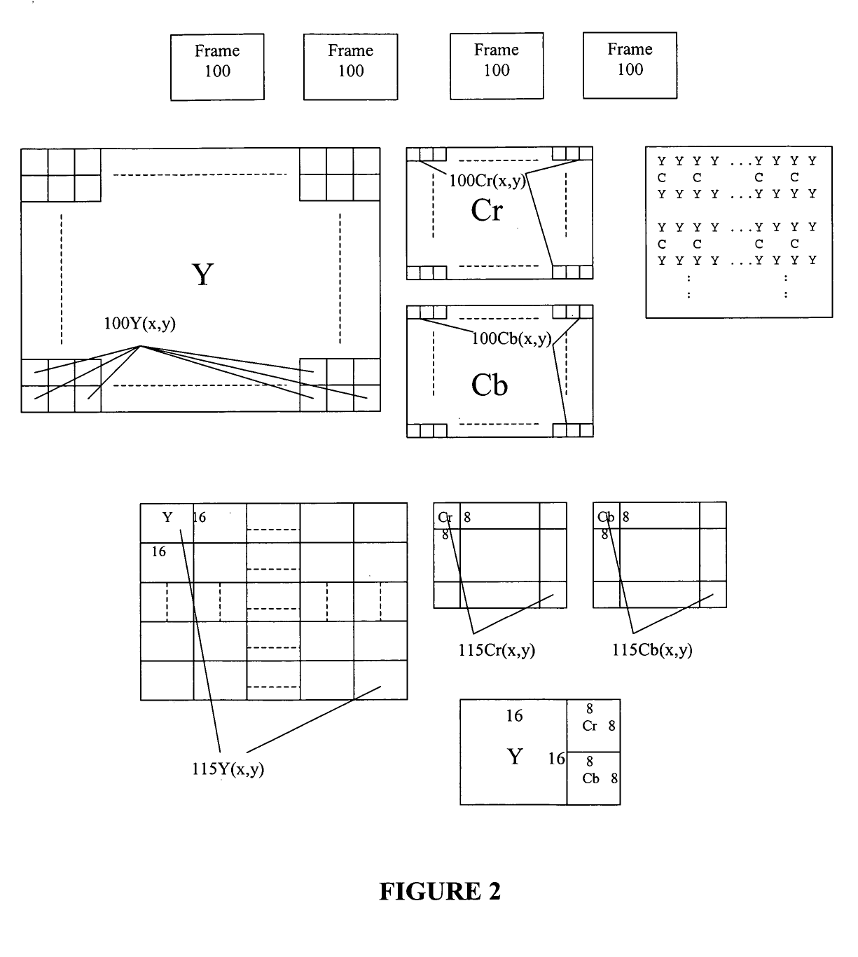

Referring now to FIG. 2, there is illustrated a block diagram of a frame 100. A video camera captures frames 100 from a field of view during time periods known as frame durations. The successive frames 100 form a video sequence. A frame 100 comprises two-dimensional grid(s) of pixels 100(x,y). For color video, each color component is associated with a two-dimensional grid of pixels. For example, a video can include a luma, chroma red, and chroma blue components. Accordingly, the luma, chroma red, and chroma blue components are associated with a two-dimensional grid of pixels 100Y(x,y), 100Cr(x,y), and 100Cb(x,y), respectively. When the grids of two dimensional pixels 100Y(x,y), 100Cr(x,y), and 100Cb(x,y) from the frame are overlayed on a display device 110, the result is a picture of the field of view at the frame duration that the frame was captured.

Generally, the human eye is more perceptive to the luma characteristics of video, compared to the chroma red and chroma blue characteristics. Accordingly, there are more pixels in the grid of luma pixels 100Y(x,y) compared to the grids of chroma red 100Cr(x,y) and chroma blue 100Cb(x,y). In the MPEG 4:2:0 standard, the grids of chroma red 100Cr(x,y) and chroma blue pixels 100Cb(x,y) have half as many pixels as the grid of luma pixels 100Y(x,y) in each direction.

The chroma red 100Cr(x,y) and chroma blue 100Cb(x,y) pixels are overlayed the luma pixels in each even-numbered column 100Y(x, 2y) between each even, one-half a pixel below each even-numbered line 100Y(2x, y). In other words, the chroma red and chroma blue pixels 100Cr(x,y) and 100Cb(x,y) are overlayed pixels 100Y(2x+½, 2y).

A luma pixels of the frame 100Y(x,y), or top/bottom fields 110YT/B(x,y) can be divided into 16×16 pixel 100Y(16x→16x+15, 16y→16y+15) blocks 115Y(x,y). For each block of luma pixels 115Y(x,y), there is a corresponding 8×8 block of chroma red pixels 115Cr(x,y) and chroma blue pixels 115Cb(x,y) comprising the chroma red and chroma blue pixels that are to be overlayed the block of luma pixels 115Y(x,y). A block of luma pixels 115Y(x,y), and the corresponding blocks of chroma red pixels 115Cr(x,y) and chroma blue pixels 115Cb(x,y) are collectively known as a macroblock 120. The macroblocks 120 can be grouped into groups known as slice groups 122.

The ITU-H.264 Standard (H.264), also known as MPEG-4, Part 10, and Advanced Video Coding, encodes video on a frame by frame basis, and encodes frames on a macroblock by macroblock basis. H.264 specifies the use of spatial prediction, temporal prediction, DCT transformation, interlaced coding, and lossless entropy coding to compress the macroblocks 120.

Spatial Prediction

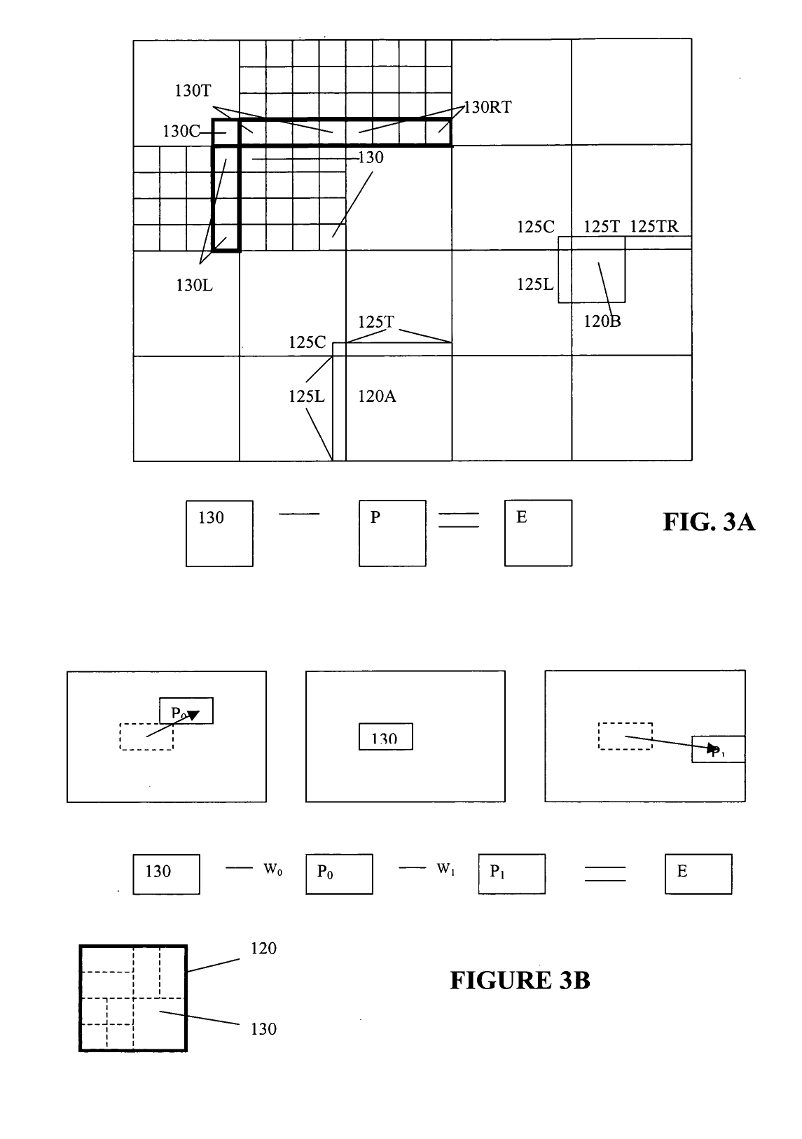

Referring now to FIG. 3A, there is illustrated a block diagram describing spatially encoded macroblocks 120. Spatial prediction, also referred to as intraprediction, involves prediction of frame pixels from neighboring pixels. The pixels of a macroblock 120 can be predicted, either in a 16×16 mode, an 8×8 mode, or a 4×4mode.

In the 16×16 and 8×8 modes, e.g, macroblock 120a, and 120b, respectively, the pixels of the macroblock are predicted from a combination of left edge pixels 125L, a corner pixel 125C, and top edge pixels 125T. The difference between the macroblock 120a and prediction pixels P is known as the prediction error E. The prediction error E is calculated and encoded along with an identification of the prediction pixels P and prediction mode, as will be described.

In the 4×4 mode, the macroblock 120c is divided into 4×4 partitions 130. The 4×4 partitions 130 of the macroblock 120a are predicted from a combination of left edge partitions 130L, a corner partition 130C, right edge partitions 130R, and top right partitions 130TR. The difference between the macroblock 120a and prediction pixels P is known as the prediction error E. The prediction error E is calculated and encoded along with an identification of the prediction pixels and prediction mode, as will be described. A macroblock 120 is encoded as the combination of the prediction errors E representing its partitions 130.

Temporal Prediction

Referring now to FIG. 3B, there is illustrated a block diagram describing temporally encoded macroblocks 120. The temporally encoded macroblocks 120 can be divided into 16×8, 8×16, 8×8, 4×8, 8×4, and 4×4 partitions 130. Each partition 130 of a macroblock 120, is compared to the pixels of other frames or fields for a similar block of pixels P. A macroblock 120 is encoded as the combination of the prediction errors E representing its partitions 130.

The similar block of pixels is known as the prediction pixels P. The difference between the partition 130 and the prediction pixels P is known as the prediction error E. The prediction error E is calculated and encoded, along with an identification of the prediction pixels P. The prediction pixels P are identified by motion vectors MV. Motion vectors MV describe the spatial displacement between the partition 130 and the prediction pixels P. The motion vectors MV can, themselves, be predicted from neighboring partitions.

The partition can also be predicted from blocks of pixels P in more than one field/frame. In bi-directional coding, the partition 130 can be predicted from two weighted blocks of pixels, P₀ and P₁. According a prediction error E is calculated as the difference between the weighted average of the prediction blocks w₀P₀+w₁P₁ and the partition 130. The prediction error E, an identification of the prediction blocks P₀, P₁ are encoded. The prediction blocks P₀ and P₁ are identified by motion vectors MV.

The weights w₀, w₁ can also be encoded explicitly, or implied from an identification of the field/frame containing the prediction blocks P₀ and P₁. The weights w₀, w₁ can be implied from the distance between the frames/fields containing the prediction blocks P₀ and P₁ and the frame/field containing the partition 130. Where T₀ is the number of frame/field durations between the frame/field containing P₀ and the frame/field containing the partition, and T₁ is the number of frame/field durations for P₁,

w₀=1−T₀/(T₀+T₁)

w₁=1−T₁/(T₀+T₁)

Dct, Quantization, and Scanning

Referring now to FIG. 3C, there is illustrated a block diagram describing the encoding of the prediction error E. With both spatial prediction and temporal prediction, the macroblock 120 is represented by a prediction error E. The prediction error E is also two-dimensional grid of pixel values for the luma Y, chroma red Cr, and chroma blue Cb components with the same dimensions as the macroblock 120.

The discrete cosine transformation (DCT) transforms 4×4 partitions 130(0,0) . . . 130(3,3) of the prediction error E to the frequency domain, thereby resulting in corresponding sets 135(0,0) . . . 135(3,3) of frequency coefficients f₀₀ . . . f₃₃. The sets of frequency coefficients are then quantized and scanned, resulting in sets 140(0,0) . . . 140(3,3) of quantized frequency coefficients, F₀ . . . Fₙ. A macroblock 120 is encoded as the combination of its partitions 130.

Macroblock Interdependencies in H.264

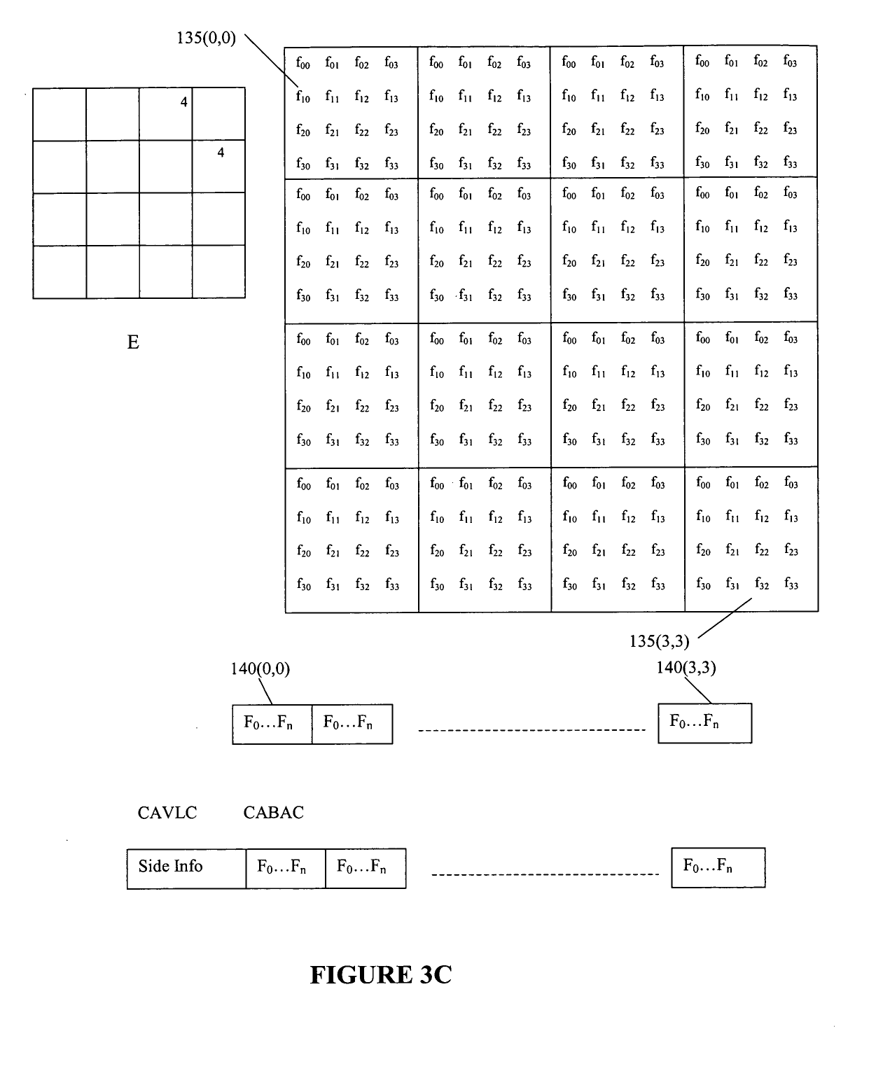

Referring now to FIG. 4, there is illustrated a block diagram describing macroblock interdependencies among macroblocks of a frame 100, where macroblocks are processed along a first row 10 from left to right. For macroblock X to be processed, the shaded macroblocks are typically processed prior to macroblock X. A subset of previously processed macroblocks A,B,C, and D that are located adjacent to macroblock X contains information that is used to process macroblock X. Accordingly, macroblock X is data dependent on macroblocks A,B,C, and D. In this example, the data in macroblock X may be predicted using a function f that operates on the previously processed data from macroblocks A,B,C, and D, where pred(X)=f(A,B,C,D).

The data from macroblock X that can be predicted from macroblocks A,B,C and D can comprise a variety of data. As mentioned above, in some cases frames are spatially predicted or intrapredicted. In such cases, pixel data from macroblock X is predicted from pixel data from macroblocks A, B, C, and D. In other cases motion vectors from macroblock X can be predicted from motion vectors from macroblocks A, B, C, and D. The pixel data and motion vectors are but a few examples of data from macroblock X that can be predicted from macroblocks A, B, C, and D.

Data compression such as H.264 allow transferring and storage of large amounts of media, such as audio and video, with less bandwidth and memory. However, decompressing compressed data utilizes a large amount of computation and processing. This can dramatically increase the load on the processing elements of a decoder, especially for presenting the media in real time.

Parallel processing is a popular approach for processing and computationally intense operations. Parallel processing uses multiple processing elements to perform different portions of the operation simultaneously. For example, multiple macroblocks 120 can be decoded simultaneously.

However, interdependencies among macroblocks 120 complicate parallel processing. For example, data from macroblock X is dependent on data from macroblocks A, B, C, and D. Therefore, macroblocks A, B, C, and D are to be decoded prior to decoding macroblock X.

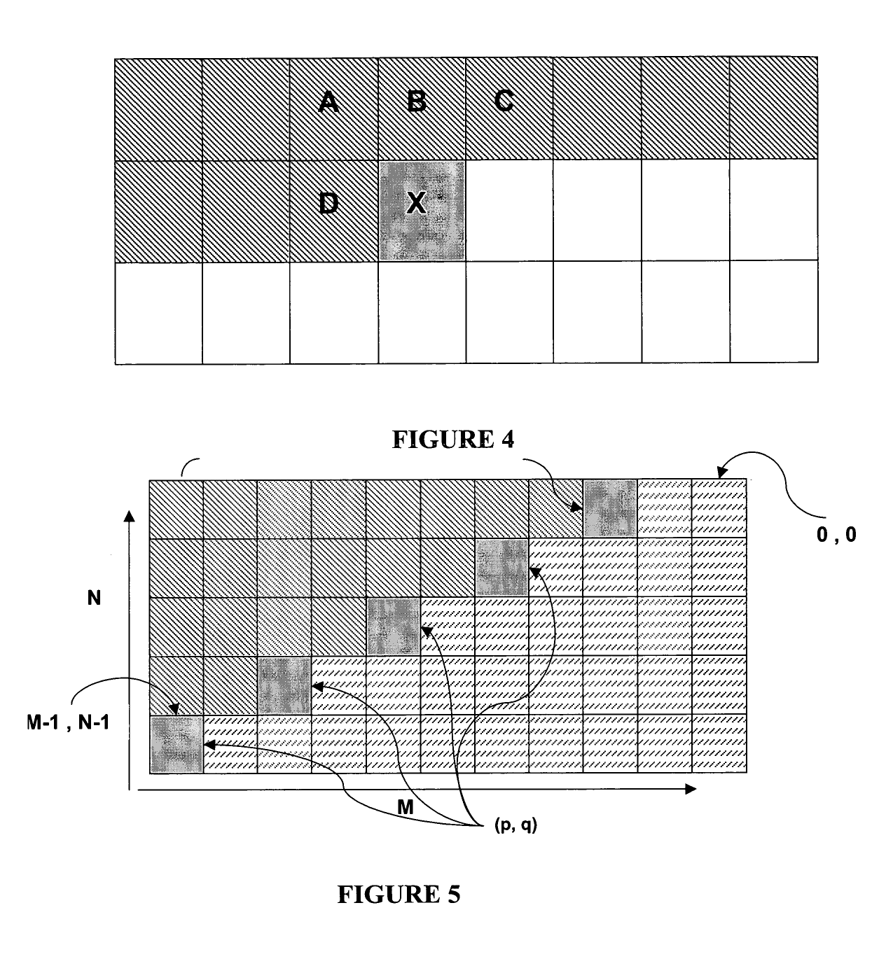

Referring now to FIG. 5, there is illustrated a block diagram of macroblocks that are data independent of each other. Each of the macroblocks are associated with a column number 0 . . . M-1 and row number 0 . . . N-1. A macroblock at (a,b) is located in column a and row b. For a particular macroblock (m,n), each of the macroblocks (p,q) according to the equation below are data independent with respect to one another and macroblock (m,n).

(p,q)=(m+j, n+k), where j=−2k, k is a non-zero integer, 0<=n+k<N, and 0<=m+j<M

Accordingly, macroblocks (m,n) and (p,q) can be decoded in parallel.

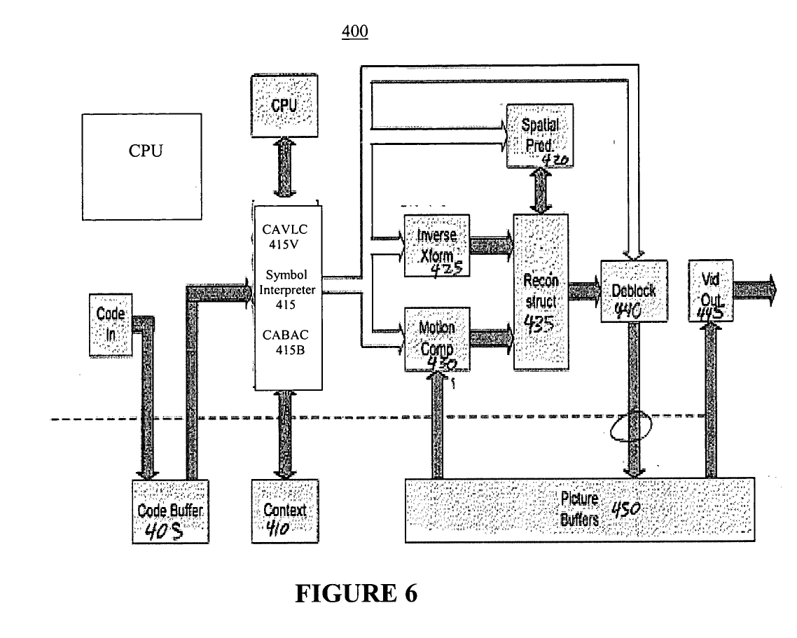

Referring now to FIG. 6, there is illustrated a block diagram describing an exemplary video decoder 400 in accordance with an embodiment of the present invention. The video decoder 400 includes a code buffer 405 for receiving a video elementary stream. The code buffer 405 can be a portion of a memory system, such as a dynamic random access memory (DRAM). A symbol interpreter 415 in conjunction with a context memory 410 decode the CABAC and CAVLC symbols from the bitstream. The context memory 410 can be another portion of the same memory system as the code buffer 405, or a portion of another memory system.

The symbol interpreter 415 includes a CAVLC decoder 415V and a CABAC decoder 415B. The CAVLC decoder 415V decodes CAVLC symbols, resulting in the sets 140 of quantized frequency coefficients F₀ . . . Fₙ. The CABAC decoder 415B decodes the CABAC symbols resulting in the side information.

The symbol interpreter 415 provides the sets of scanned quantized frequency coefficients F₀ . . . Fₙ to an inverse scanner, quantizer, and transformer (ISQDCT) 425. Depending on the prediction mode for the macroblock 120 associated with the scanned quantized frequency coefficients F₀ . . . Fₙ, the symbol interpreter 415 provides the side information to either spatial predicters 420 (if spatial prediction) or motion compensators 430 (if temporal prediction).

The ISQDCT 425 constructs the prediction error E. The spatial predictors 420 generate the prediction pixels P for spatially predicted macroblocks while the motion compensators 430 generate the prediction pixels P, or P0, P1 for temporally predicted macroblocks. The motion compensators 430 retrieve the prediction pixels P, or P0, P1 from picture buffers 450 that store previously decoded frames or fields.

Pixel reconstructors 435 receive the prediction error E from the ISQDCT 425, and the prediction pixels from either the motion compensators 430 or spatial predictors 420. The pixel reconstructors 435 reconstruct the macroblock 120 from the foregoing information and provides the macroblock 120 to a deblocker 440. The deblocker 440 smoothes pixels at the edge of the macroblock 120 to prevent the appearance of blocking. The deblocker 440 writes the decoded macroblock 120 to the picture buffer 450.

A display engine 445 provides the frames 100 from the picture buffer 450 to a display device. The symbol interpreter 415, the ISQDCT 425, spatial predictors 420, motion compensators 430, pixel reconstructors 435, and display engine 445 can be hardware accelerators under the control of a central processing unit (CPU).

The CPU can determine the macroblocks that are data independent with respect to one another. In one aspect of the present invention, each of the spatial predictors 420 can operate on particular ones of the data independent macroblocks in parallel. In another aspect of the present invention, each of the motion compensators 430 can operate on particular ones of the data independent macroblocks in parallel. In another aspect of the present invention, each of the pixel reconstructors 435 can operate on particular ones of the data independent macroblocks in parallel.

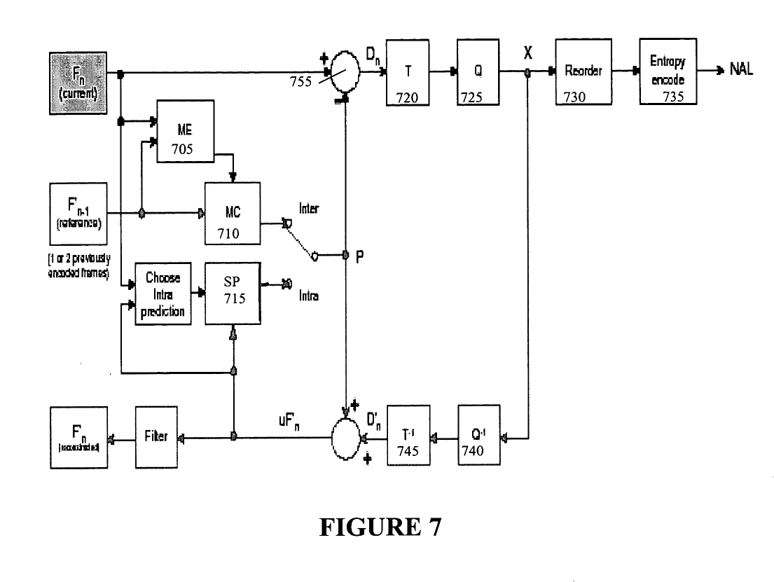

Referring now to FIG. 7, there is illustrated a block diagram describing an exemplary video encoder in accordance with an embodiment of the present invention. The video encoder encodes video data comprising a set of frames F₀ . . . Fₙ. The video encoder comprises motion estimators 705, motion compensators 710, spatial predictors 715, transformation engine 720, quantizer 725, scanner 730, entropy encoders 735, inverse quantizer 740, and inverse transformation engine 745. The foregoing can comprise hardware accelerator units under the control of a CPU.

When an input frame Fₙ is presented for encoding, the video encoder processes the frame Fₙ in units of macroblocks. The video encoder can encode each macroblock using either spatial or temporal prediction. In each case, the video encoder forms a prediction block P. In spatial prediction mode, the spatial predictors 715 form the prediction macroblock P from samples of the current frame Fₙ that was previously encoded. In temporal prediction mode, the motion estimators 705 and motion compensators 710 form a prediction macroblock P from one or more reference frames. Additionally, the motion estimators 705 and motion compensators 710 provide motion vectors identifying the prediction block. The motion vectors can also be predicted from motion vectors of neighboring macroblocks.

A subtractor 755 subtracts the prediction macroblock P from the macroblock in frame Fₙ, resulting in a prediction error E. Transformation engine 720 and quantizer 725 block transform and quantize the prediction error E, resulting in a set of quantized transform coefficients X. The scanner 730 reorders the quantized transform coefficients X. The entropy encoders 735 entropy encode the coefficients.

The video encoder also decodes the quantized transform coefficients X, via inverse transformation engine 745, and inverse quantizer 740, in order to reconstruct the frame Fₙ for encoding of later macroblocks, either within frame Fₙ or other frames.

The CPU can determine the macroblocks that are to be encoded data independently with respect to one another. In one aspect of the present invention, each of the motion estimators 705 and motion compensators 710 can operate on different ones of the macroblocks in parallel. In another aspect of the present invention, each of the spatial predictors 715 can operated on different ones of the macroblocks in parallel. In another aspect of the present invention, the CPU can identify different portions of the video data that can be entropy encoded data independently with respect to each other, each of the entropy encoders can entropy encode the different ones of the portion in parallel.

The embodiments described herein may be implemented as a board level product, as a single chip, application specific integrated circuit (ASIC), or with varying levels of the decoder system integrated with other portions of the system as separate components.

The degree of integration of the decoder system will primarily be determined by the speed and cost considerations. Because of the sophisticated nature of modern processor, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope.

Therefore, it is intended that the present invention not be limited to the particular embodiment disclosed, but that the present invention will include all embodiments falling within the scope of the appended claims.

1. A decoder system for decoding encoded video data, said decoder system comprising:
a host processor for finding a first portion of the encoded video data and a second portion of the encoded video data, wherein the first portion of the encoded video data and the second portion of the encoded video data are data independent from each other;
a first decoder engine for decoding the first portion of the encoded video data; and
a second decoder engine for decoding the second portion of the encoded video data, while the first decoder engine decodes the first portion of the encoded video data.

2. The decoder system of claim 1, wherein the first portion of the encoded video data comprises a first macroblock and the second portion of the encoded video data comprises a second macroblock.

3. The decoder system of claim 2, wherein the first macroblock is associated with a first row and the second macroblock is associated with a second row, the second row adjacent to the first row.

4. The decoder system of claim 3, wherein the first macroblock is associated with a first column and the second macroblock is associated with a second column, the first column and the second column being separated by at least two macroblocks.

5. The decoder system of claim 2, wherein the first decoding engine comprises a first spatial predictor for generating a first prediction block from a set of macroblocks neighboring the first macroblock, and wherein the second decoding engine comprises a second spatial predictor for generating a second prediction block from a set of macroblocks neighboring the second macroblock.

6. The decoder system of claim 1, wherein the first decoding engine comprises a first motion compensator for generating a first prediction block from one or more reference frames, and wherein the second decoding engine comprises a second motion compensator for generating a second prediction block from one or more reference frames.

7. The decoder system of claim 1, wherein the first decoding engine comprises a first pixel reconstructor for reconstructing the first portion of the encoded video data, and wherein the second decoding engine comprises a second pixel reconstructor for reconstructing the second portion of the encoded video data.

8. The decoder system of claim 1, wherein the video data is encoded in accordance with the H.264 standard.

9. A method for decoding encoded video data, said method comprising:
finding a first portion of the encoded video data and a second portion of the encoded video data, wherein the first portion of the encoded video data and the second portion of the encoded video data are data independent from each other;
decoding the first portion of the encoded video data; and
decoding the second portion of the encoded video data, while decoding the first portion of the encoded video data.

10. The method of claim 9, wherein the first portion of the encoded video data comprises a first macroblock and the second portion of the encoded video data comprises a second macroblock.

11. The method of claim 10, wherein the first macroblock is associated with a first row and the second macroblock is associated with a second row, the second row adjacent to the first row.

12. The method of claim 11, wherein the first macroblock is associated with a first column and the second macroblock is associated with a second column, the first column and the second column being separated by at least two macroblocks.

13. The method of claim 10, wherein decoding the first portion of the encoded data further comprises generating a first prediction block from a set of macroblocks neighboring the first macroblock and wherein decoding the second portion of the encoded data further comprises generating a second prediction block from a set of macroblocks neighboring the second macroblock.

14. The method of claim 9, wherein decoding the first portion of the encoded video data further comprises generating a first prediction block from one or more reference frames and wherein decoding the second portion of the encoded video data further comprises generating a second prediction block from one or more reference frames.

15. The method of claim 9, wherein decoding the first portion of the encoded video data further comprise reconstructing the first portion of the encoded video data and wherein decoding the second portion of the encoded video data further comprise reconstructing the second portion of the encoded video data.

16. The method of claim 9, wherein the encoded video data is encoded in accordance with the H.264 standard.

17. An encoder system for encoding video data, said encoder system comprising:
a host processor for selecting a first portion of the video data and a second portion of the video data;
a first encoder engine for encoding the first portion of the video data independently from the second portion of the video data, thereby resulting in a first encoded portion of the video data; and
a second encoder engine for encoding the second portion of the video data independently from the first portion of the video data, thereby resulting in a second encoded portion of the video data, while the first encoder engine encodes the first portion of the video data.

18. The encoder system of claim 17, wherein the first encoded portion of the video data comprises a first macroblock and the second encoded portion of the video data comprises a second macroblock.

19. The encoder system of claim 18, wherein the first macroblock is associated with a first row and the second macroblock is associated with a second row, the second row adjacent to the first row.

20. The encoder system of claim 19, wherein the first macroblock is associated with a first column and the second macroblock is associated with a second column, the first column and the second column being separated by at least two macroblocks.

21. The encoder system of claim 18, wherein the first encoding engine comprises a first spatial predictor for predicting the first macroblock from a set of macroblocks neighboring the first macroblock, and wherein the second encoding engine comprises a second spatial predictor for predicting the second macroblock from a set of macroblocks neighboring the second macroblock.

22. The decoder system of claim 17, wherein the first decoding engine comprises a first motion compensator for predicting the first portion of the video data from one or more reference frames, and wherein the second decoding engine comprises a second motion compensator for predicting the second portion of the video data from one or more reference frames.

23. An method for encoding video data, said method comprising:
selecting a first portion of the video data and a second portion of the video data;
encoding the first portion of the video data independently from the second portion of the video data, thereby resulting in a first encoded portion of the video data; and
encoding the second portion of the video data independently from the first portion of the video data, thereby resulting in a second encoded portion of the video data, while encoding the first portion of the video data.

24. The method of claim 23, wherein the first encoded portion of the video data comprises a first macroblock and the second encoded portion of the video data comprises a second macroblock.

25. The encoder system of claim 24, wherein the first macroblock is associated with a first row and the second macroblock is associated with a second row, the second row adjacent to the first row.

26. The encoder system of claim 25, wherein the first macroblock is associated with a first column and the second macroblock is associated with a second column, the first column and the second column being separated by at least two macroblocks.

27. The encoder system of claim 24, wherein the encoding the first portion of the video data comprises predicting the first macroblock from a set of macroblocks neighboring the first macroblock, and wherein encoding the second portion of the video data comprises a predicting the second macroblock from a set of macroblocks neighboring the second macroblock.

28. The decoder system of claim 23, wherein the encoding the first portion of the video data comprises predicting the first portion of the video data from one or more reference frames, and wherein the encoding the second portion of the video data comprises predicting the second portion of the video data from one or more reference frames.
